(19) United States
(12) Patent Application Publication
(10) Pub. No.: US 2006/0020916 A1
(43) Pub. Date: Jan. 26, 2006

(54) Automatic Derivation of Morphological, Syntactic, and Semantic Meaning from a Natural Language System Using a Monte Carlo Markov Chain Process

(76) Inventors: David James Allison, Mill Valley, CA (US); Karmelit Belle Alon, Mill Valley, CA (US)

Correspondence Address: DAVID ALLISON, 334 PINE HILL RD, MILL VALLEY, CA, 94941, US

(21) Appl. No.: 10/710,560

(22) Filed: Jul. 20, 2004

(51) Int. Cl. G06F 9/44

(52) U.S. Cl. 717/114; 717/117; 717/116

(57) ABSTRACT

A method for deriving the morphology, syntax, and semantics of a language system (comprised of untagged free text) is presented. The concept of the “language object” (a unique data structure containing information concerning the behavior of a given segment of the input language) is introduced, and is shown to be useful in the analysis of a language system when utilized by a Monte Carlo Markov Chain rule engine to discern probabilities of various language rules and the existence of various “language objects.” This process of positing and testing language objects and rules functions on morphologic, syntactic and semantic levels, building a comprehensive understanding of language use and structure from base elements up to the complex systems of human expression.

### BACKGROUND OF INVENTION

1. Field of the Invention

### BACKGROUND OF THE FIELD

Natural Language Processing is a field devoted to allowing machines the ability to understand human language, in all its varied forms and expressions. Until now, the field has primarily been characterized by work involving systems crafted to attempt to explain language from a static view-point (whereby a static grammar or other such descriptive system is applied to a corpus), or systems in which a great deal of human time and effort is used to train a machine to understand a small subset of language (such as the requirement for manual word-sense disambiguation and semantic tagging for a large corpus).

Our invention allows comprehension of meaning expressed in a textual language system—and natural communication using that language system—by machines. We show how a system can be developed to derive the morphological, syntactic, and semantic meaning of all components of a language system, from a single character large documents. We show how such a system can be useful in fields like human bias analysis, business case analysis, business efficiency analysis, expert system creation, artificial intelligence systems, and human-computer interaction and understanding.

Our invention introduces the structure of a “language object” and we show how a collection of such structures can be used to efficiently and accurately describe a language system, and how the structures can be used together to create rulesets for the language system which allow the characterization of morphological, syntactic, and semantic meaning within the language system.

Our invention allows the creation of a natural language artificial intelligence, which can communicate in a natural manner, a manner consistent with its environment and purpose. Such an artificial intelligence could be used in expert systems and business analysis to determine inefficiencies within organizations and departments, as well as to suggest improvements based upon its findings.

2. Discussion of Prior Art

Prior art relating to natural language processing and semantic parsing generally falls into one of two categories: tagging systems and latent semantic analysis.

Tagging systems rely on “knowledge databases,” which contain a dictionary of words and a set of grammar rules. The knowledge database of each system must be hard-coded before any parsing can occur. In other words, programmers must include within the program a static array of rules for interpreting data. For example, the commercially available system CLAWS (University of Lancaster, England) has a lexicon of approximately 50,000 words, all identified by a number of features, such as part of speech (e.g. “various” is labeled an adjective). In addition, CLAWS operates based on a set of unchanging rules that are taken as true for all input data (e.g. words [ending] inness will normally be nouns). There are a number of similar systems that function in the same manner, with a few variations on the method of tagging, or the data contained within the tag, but a typical tagging system would parse a sentence such as,

The presidential campaigns emphasized character.

to a version, perhaps with more or less detail, of the following:

[NP The (determiner) presidential (adjective) campaigns (noun)] [VP emphasized (PT verb) character (noun)]

A selection of tagging systems that operate with the described method follows:

-Electronic Dictionary Using Dictionary Entry Keys (U.S. Pat. No. 6,651,220, issued on Nov. 18, 2003 to Penteroudakis, et al). Provides a dictionary that includes a lexicon tagged by such features as number (singular v. plural), part of speech (adjective, noun, etc.), inflection (inflectable v. not inflectable), and definitiveness (definite v. indefinite), as well as “attribute 'senses,” which comprise the possible meanings and implications of a given entry.

-Method and System for Text Analysis Based on the Tagging, Processing, and/or Reformatting of the Input Text (U.S. Pat. No. 6,658,377, issued on Dec. 2, 2003 to Anward, et al). As in other tagging systems, various linguistically relevant attributes of words are set in the knowledge database, and then applied to the input text. If necessary, input text is reformatted according to “a set of proscribed parameters.”

-Relational Text Index Creation and Searching (U.S. Pat. No. 6,741,988, issued on May 25, 2004 to Wakefield, et al). Creates “caseframes” to relate instances of a word in an input text based on a hard-coded parser that assigns part-of-speech tags, along with tags signifying linguistic roles (e.g. subject, direct object). Words in a given sentence or document are then organized based on the tags.

The traditional embodiment of a tagging system suffers from the limitations that a hard-coded knowledge database necessitates. In other words, it assumes too much about language to be consistent with the mobile and unstable nature of language. Static dictionaries and rule sets disallow adaptability as well as inclusiveness in parsing a wide variety of texts. Only the small subset of language—the subset that complies with the dictionaries and structure of a system's knowledge database—can successfully undergo disambiguation. A tagging system can interpret data in terms of known information, but it cannot learn a new grammar rule, or how to deal with the rather lax standards of much of the Internet.

Latent Semantic Analysis (LSA), though lacking the rigidity of a tagging system's knowledge database, is stunted by its assumption that literal proximity (that is, the closeness of words) correlates directly with semantic relevance and meaning. LSA interprets text by means of a matrix that lays out words and their occurrences in a dimensional framework. In such a system, the key factor in determining semantic intent is proximity of words and types of words to each other. The inherent assumption, then, of LSA is that proximity and word-level constituents are paramount in Natural Language Processing. LSA sacrifices accuracy and completeness in ignoring both order of words and hierarchal constituency (that is, the notion that an inflectional phrase can contain a noun phrase and a verb phrase, each of which in turn contain adjective phrases, prepositional phrases, and so on). In LSA, the difference between

[Jane said [she would see Bob on Friday.]] (that is, Jane will see Bob on Friday, and has told him so) and [[Jane said she would see Bob] on Friday.] (that is, on Friday Jane in-formed Bob she would be seeing him)

is negligible, which is a problem in attempting to imitate human language interpretation. While proximity is often an important aspect of semantic analysis, it is not the whole picture. Computational disregard of the syntactic hierarchy that structures and clarifies statements for human readers results in a system that inaccurately handles Natural Language Processing. Additionally, the present embodiments of LSA ignore aspects of syntax essential in human interpretation; inflectional affixes (those that denote verb tense, plurals, adverbials, etc.) as well as common words (“the,” “a,” “and,” etc.) are stripped from the input text. As a result, root words become paramount, and the more subtle differences possible in human expression are missed. For example, LSA would not distinguish between

[She completed the research and turned in the documents today.] and [She completes the research and turns in a document today.]

In this case, timing and status of work, as well as the specificity of the named documents, would be unclear in an LSA model. For information analysis, this is crucial; in the second statement, a correlation between “a document” and “the research” is not necessary, whereas in the first statement a human reader would assume there was such a correlation. In either case, LSA makes no distinction. In the more general context of any given input data, this focus on roots, and the ignorance of hierarchal syntax this requisites, could overlook the elucidating details of a text.

This reliance of LSA on proximity and word-level structure, like the reliance of tagging systems on knowledge databases, severely restricts the analytic and interpretive capabilities of current Natural Language Processing.

### SUMMARY OF INVENTION

The present invention overcomes the limitations listed in the Background and Prior Art sections by providing a method and system for semantic analysis and Natural Language Processing based on a purely probabilistic means.

In deriving the syntax and semantics of input text, the present invention uses a Monte Carlo Markov Chain process to posit both the existence of “language objects” (unique data structures containing information concerning the behavior of a given segment of the input language) and the rules that govern the interactions of these various language objects. The ability of these language objects and rules to describe the language data is tested across the corpus to ensure a high likelihood of descriptive accuracy.

This process of positing and testing language objects and rules functions on morphologic, syntactic and semantic levels, building a comprehensive understanding of language use and structure from base elements up to the complex systems of human expression.

### DETAILED DESCRIPTION

Before an illustrative embodiment of the methods of the present invention may be presented, it is ideal to define a novel data structure, the “language object,” and how it is used in our methods:

The “language object” is a term we will use to refer to the data structure that holds constituent parts of a language (realized—i.e. visible—and rule based—i.e. no physical representation other than acting on other constituent parts) and which contains “existence” and “appearance” states and exists as an object in the sense of the term as understood in the field of object oriented computer programming—that is, the object holds data and methods which act on data. The language object contains data about its representation and rules that can be applied to said data and other language objects, and these rules and data are classified either as existence states or appearance states:

1. Existence States:

a. Describe the environment in which a language object may appear

b. Define possible environments in terms of a language object's relation to other language objects.

2. Appearance States:

a. Describe how a language object operates with and on other language objects—that is, what rules it may apply to other objects, what relative meanings it may take, what language objects it may require or act as an immediate super-constituent of.

b. Contain information regarding the scenarios in which a language object's actions, rules, and meanings occur. That is, allow existence states to act as influences on appearance states making a certain appearance state more or less likely given a certain environment.

Given the notion of the language object, it is necessary to introduce the generalized rule engine which makes use of language objects, and helps in their creation and destruction. The rule engine is based upon a Monte Carlo Markov Chain process for the creation of language object rules and language system rules. This entails that the language system at any given moment during analysis may be seen as a combinatoric structure, consisting of a set of language objects, each of which consists of a set of Bayesian networks describing the relative probabilities of the production and creation of various rules and manifestations of data within said language objects. The rule engine moves the combinatoric structure of the language system being analyzed towards a more accurate description of what actually takes place in human use of said language system as time passes in the analysis process. The rule engine does this by updating and creating Bayesian networks (or truth networks) in the language objects of the language system, based upon observations of the following data:

1. Proximity of one language object to another on a tree structure (defined by the network of constituent relationships of the language objects in the language system at the time of analysis)—this allows the creation of morpheme, word, and word-phrase level language objects, due to relatively high chances of proximity of certain character combinations (leading to morphemes), certain morpheme combinations (leading to words), and certain word combinations (leading to phrases).

2. Existence of other objects with relation to an object-this allows the creation of generalized phrase and semantic structure language objects, as well as causal relationship language objects, due to systemic methods of defining said relationships and phrases in language (for instance, context-sensitive, rule-based patterns for causal relationships existing in Verb Phrases or more broadly in Inflectional Phrases).

3. Application of a language object rule (that is, a trigger for a new rule based on the application of another rule)—this allows for rule ordering, a common feature observed in language, and ensures that there are no arbitrary limits placed on ordering of rules (for instance, the arbitrary limits placed by more limited methods of analysis, which disallow the application of morphologically sensitive rules after a syntactic rule at the sentence level has already been applied, or which disallow the application of of a syntactic rule that is morphologically sensitive).

These rules are repeatedly tested over the life of a language object, based upon a Monte Carlo algorithm which ensures that all rules are given adequate testing (by weighting the testing of lesser-tested rules higher than the testing of rules that have undergone many tests). This process moves the overall combinatoric structure of the language system towards a more apt description of the actual language use patterns of humans.

An illustrative embodiment of the creation of a word level language object from a corpus of free-text data using the Monte Carlo Markov Chain process rule engine:

At the onset of this embodiment, we assume that the Monte Carlo Markov Chain has created a language object which has a high degree of probability for determining the separation between two word-level language objects (for instance, an object representing the space key, as well as other forms of punctuation such as the comma and period). It has done this through proximity tests as discussed above.

While analyzing data, the rule engine happens upon a new word in the corpus, “prosperity.” It posits a rule that this new entity is a word-level language object, and tests for the existence of it elsewhere in the corpus next to the word-delimiter mentioned previously. It finds that the language object “prosperity” never appears next to another language object with no delimiter separating the two. This strengthens the description network of “prosperity” as a word level language object. The rule engine goes on to posit several more rules regarding “prosperity” including that it appears within the confines of instances of the language object it has created to express Noun Phrases, giving further weight to rule that “prosperity” is a word level object. The rule engine also posits that in these Noun Phrase expressions of “prosperity,” adjectival phrases and adjectives may modify the word in the same manner as these adjectival phrases and adjectives modify other nouns. This adds even more weight to the expression of “prosperity” as a word, and begins to define its part of speech as a noun, or one of the possible direct constituents of the Noun Phrase language object.

In summary, the rule engine uses the following steps to create a rule for a language object (or to create a new language object within the language system):

1. Observe an occurrence (an “existence” state) of a lan-object or character in the corpus data. This existence state is a method of describing a possible reason for the appearance of a specific language object.

2. Test this existence state across many appearances of the language object; in this manner, eliminate rules which have a low degree of success for describing the language system, and make prominent (that is, make more probable the expression of) those rules with a high degree of success for describing the system.

3. Re-test the rule over time to ensure that it remains a valid rule for describing the language system, and update its Bayesian network accordingly. For instance, if it becomes unreliable as a descriptor, its application rate should be lowered so that it doesn't get as much chance to be applied.

The process for morpheme derivation works in much the same way as the above example, except that instead of starting with a word separator (such as the space), the rule positing engine needs nothing to start. As such, the steps for morpheme derivation are as follows:

1. Use proximity tests to begin to derive prevalence of co-occurrence between the base set of characters in the language system being analyzed.

2. Using these proximity tests, create language objects which correspond to the morphemes of a language. These objects will necessarily contain information about the ability of a morpheme to exist in all of its natural environments (that is, the environments which allow the morpheme's existence in the corpus being analyzed).

A generalization of the steps for word-level and multi-word-level language object creation follows:

1. Apply the language objects created in the morpheme tests to each other; determine the allowable groupings of morphemes into words, creating rules about the interactions of morphemes in the formation of words. The word system of a language will necessarily include morphological process information about the language—for instance, how words are formed, and which morphemes are allowed next to each other.

2. Using the word objects, create phrasal objects containing multiple words. These rules will necessarily encompass common multi-word phrases (or multi-word-entities) in a language.

3. Both of processes 1 and 2 will begin to incorporate semantic data about the words and multi-word-entities of a language, due to the creation of occurrence-relationship rules for words and word phrases within larger phrase structures. These relationships are superior to those formed in methods such as Latent Semantic Analysis, which only has knowledge of direct proximity relationships of words and phrases, rather than the relationships created through language objects, which express phrase and context-level dependency for meaning.

Syntactic feature language objects are a natural consequence of the creation of the previous set of language objects, as type-groupings become readily evident to the rule engine (that is, groupings based on things such as syntactic and semantic type, such as Noun Phrases and Verb Phrases). Given the multi-word-entity and word-level language objects in the system, the rule positing engine need only create language objects representing phrasal structures and semantic structures based upon co-occurrence of single and multi-word entities with other single and multi-word entities.

Notes on semantic and syntactic language object creation:

Due to the nature of the system, phrasal structures which appear to function in very limited circumstances will only be allowed in those circumstances, while more generalized phrasal structures (such as the common ‘Inflectional Phrase’ or ‘Complementizer Phrase’) will have a much greater prevalence, as they describe significantly more data in the language system.

Since none of the phrasal language objects are named (language objects are only named as a convenience in general, with their most probable character expression), it will often be useful, though not necessary, to allow a human to assist the rule-engine in naming them. This will allow a more natural analysis of the phrasal structure, while not taking for granted human tagging or intervention as a necessity. Of course, the rule engine could analyze the whole corpus and never interact with a human, but a human would benefit greatly from being able to specify what to call some of the objects the rule engine has created.

Our process for semantic derivation of a language system (and its body of free text which is not manually marked up or tagged by humans) functions in a very similar manner to the other types of derivation discussed. Its process is as follows:

1. Given phrasal structures, component structures, words and multi-word-entities, the rule engine posits the existence of semantic meaning structures. Note: rather than just co-occurrence relations for semantic analysis, like in a Latent Semantic Map, the rule-engine will have an excellent notion of the sub-structure of sentences and phrasal units, as well as full word-sense disambiguation capabilities based on the environments of the word or multi-word-entity language object. This means that semantic analysis without human intervention can be greatly improved, and the rule engine can learn from a much wider body of inferential knowledge.

2. The rule engine creates a semantic map, within the appearance states of the language objects, that describes the usage of the various language objects within the language system. This map is based upon rules contained within multi-word-entity and word objects, as well as phrasal constituent objects that describe the “application” of these objects to other objects. An example of this is a language object describing the Noun Phrase structure, which could contain a language object describing the Adjectival Phrase structure, which would contain a rule describing how the contained adjective/adverb is applied to the Noun Phrase super-structure.

An illustrative embodiment of such a semantic derivation follows:

The rule engine observes that the Noun Phrase super-structure contains, with a high degree of probability, an Adjectival Phrase and a Noun. It posits that this is due to a semantic relationship between the two language objects, and creates a rule specifying that the language object in the Adjectival Phrase position should be semantically “applied” to the object in the Noun position within the Noun Phrase super-structure. To test this, the rule engine notes that other identical noun objects within a sentence cluster have properties semantically consistent with the application of the Adjectival Phrase from the Noun Phrase super-structure. An example of this is a sentence cluster like “The red truck was parked by the sidewalk. I noted that the truck had a flat tire. The truck, however, was adorned with a for-sale sign that indicated its red color.” This group of sentences (along, of course, with many others), allows the rule engine to posit that “truck” can stand alone as a language object, that “truck” should not be applied to “red” but rather “red” to ”truck (because “truck” can stand alone), and that such an Adjectival Phrase as “red” should be applied to the noun “truck” in a Noun Phrase super-structure in a semantic manner, because this is a semantically consistent operation because the rule engine later verifies that “its” refers to the “truck” through co-occurrence tests in a Sentence Structure language object, and that “its” may also have “red” applied to it.

Of course, this is a very simplistic example, but it demonstrates the useful conclusions that a rule-based probabilistic process for applying semantic properties can make.

Using the same rule engine and system of language objects, but applied to a different corpus, our invention can easily come to semantic conclusions regarding worker or departmental efficiency in a company based upon the text it reads from internal memos, e-mails, reports, etc. These conclusions could be used to provide insight into what areas a company could improve by sharing resources, or perhaps by changing work processes or methodologies. A basic embodiment of this area of analysis is in business process analysis. Our invention is capable of coming to semantic conclusions about abstract systems, including business processes. This analysis can aid companies in determining which departments or areas are duplicating the work of other departments. The system, since it investigates the rule entities it creates, is also useful in business trend analysis, which is essentially context analysis for the body of language objects representing the businesses themselves.

Additionally, our invention can act as a general expert system, able to research topics and provide natural language answers to natural language questions about any topic for which it can find information. Using a large corpus, such as the internet, our invention can gather consensus opinions on any number of topics and news items. This is natural language parsing ability is a basic property of the construction of a system of language objects. Sentences may be parsed in their natural contexts and due to the probabilistic nature of the system, previously unseen contexts may be rapidly analyzed and understood.

Our invention can serve as a method to measure human bias in expression; semantic conclusions regarding one's biases can be based upon collections of known information about semantic interpretations of various topical data (that is, known writings with a known bias), as well as one's writing and expressive patterns. Since the system is not static in any part of its rule application or creation (that is, it has evolving Bayesian probabilistic networks to describe all rules), it is capable of coming to a highly accurate conclusion regarding any query or topic about which it can find information, including authorial bias or group bias within a corpus of writing. This is accomplished through property-association comparisons (that is, which authors apply which properties to specific language objects). Given the semantic association example above, if another author had claimed that the language object representing the truck had the color green, the system would take this as a difference of perception on the part of the two authors, and be able to make statements regarding the authors given this information about their dissimilarity. This, of course, is applicable to much larger topics than color-perception difference; for example, the process could be applied to bias detection in media analysis.

1. we claim a method of creating, encapsulating, systematizing, and using information about constituent parts of a language (realized—i.e. visible—and rule based—i.e: no physical representation other than acting on other constituent parts) called the “language-object” which contains “existence” and “appearance” states and exists as an object in the sense of the term as understood in the field of object oriented programming. The language object contains data about its representation and rules that can be applied to said data and other language objects, and data and rules these are classified either as existence states or appearance states, where existence states and appearance states are comprised in the following manner:
1. Existence states:
a. Describe the environment in which a language object may appear
b. Define possible environments in terms of a language object's relation to other language objects.
2. Appearance States:
a. Describe ways in which a language object may act on other language objects and what meanings it may take given its placement in relation to other language objects
b. Contain information regarding the scenarios in which a language object's actions, rules, and meanings occur. That is, combine existence state information with the rules, processes, and semantic information contained in appearance states.

2. We claim a generalized rule engine for creating language rules for and using language objects based upon a Monte Carlo Markov Chain process for deriving said language objects and information about them and there associations with other language objects, wherein said rule engine has the following properties:
1. The rule engine creates tests that may be based upon:
a. proximity of one language object to another on a tree structure (defined by the pre-existing network of constituent relationships in the language objects)
b. existence of other objects with relation to an object
c. application of a language object rule (that is, a trigger for a new rule based on the application of another rule)
2. Tests and applications of the rules created by such a rule engine are probabilistically based, in that repeated checks form tests that are reliable, or accurate descriptors of the language system as a whole, with a high degree of probability.
3. Reliability networks of such tests are updated regularly to ensure that only rules that are highly reliable are expressed in the language system.

3. We claim a process for morpheme derivation of a language system based upon usage of language objects and the generalized rule engine.

4. We claim a process for word and word phrase derivation of a language system based upon usage of language objects and the generalized rule engine.

5. We claim a process for syntactic derivation of a language system based upon usage of language objects and the generalized rule engine.

6. We claim a process for semantic derivation of a language system (and its body of free text which is not manually marked up or tagged by humans) based upon usage of language objects and the generalized rule engine wherein:
such a semantic derivation process has the ability to garner data regarding the semantic intent of an author through high-level language-object tests (with semantic role language objects derived probabilistically). such a semantic derivation process has the ability to associate data about language objects with authors to abstract information about bias. such a semantic derivation process has the ability to associate data about language objects derived from corpus data collected within a business with the elements of said business to abstract information about efficiency and trends within said business.
